(19) United States
(12) Patent Application Publication
(10) Pub. No.: US 2018/0028922 A1
(43) Pub. Date: Feb. 1, 2018

(54) Boot Stick

(71) Applicant: Tam Mitchell Paliotti, Geneva, NY (US)

(72) Inventor: Tam Mitchell Paliotti, Geneva, NY (US)

(21) Appl. No.: 15/225,698

(22) Filed: Aug. 1, 2016

(51) Int. Cl. A63F 13/98; A63F 13/24

(52) U.S. Cl. CPC A63F 13/98; A63F 13/24

(57) ABSTRACT

A device with a pliable middle section to allow bending of the device. The open square shape at each end of the device allow it to be inserted into another device.

### FIELD

The application relates to a device with open ends on each side to be inserted in between analogue sticks on a game controller.

### BACKGROUND

Game controllers for the PS4 and Xbox have analogue sticks on each side to be moved while playing games. The material used for the device is a Lexan plastic cut to be pliable so that it can be inserted in between the analogue sticks to hold them outward to keep a player consistently in motion in the game if the player has to temporarily walk away from the game.

### SUMMARY

The device is made of Lexan plastic cut to the specific measurements in FIG. 1.

The device is flat plastic shape which is pliable to withstand a short bend to insert in between analogue sticks on a game controller.

When the device is inserted onto a game controller, it holds the analogue sticks in an outward position.

The outward positions holds the character in a game in a moving position to prevent the player from being booted or kicked out of the game.

The character in the game will remain active while the player steps away from the game for a several minutes or a time at which the game completes.

The square shape on each end of the device will hold the analogue sticks of the controller and hold them in an outward position.

Further properties of the device in this application will be described in the detailed description

### BRIEF DESCRIPTION OF THE DRAWINGS

The detailed portion of the following description in the present application will be explained in more detail with reference to the drawing shown in which:

FIG. 1 is an isometric view of the device embodiment with specific callouts.

### DETAILED DESCRIPTION

In the following detailed description, the device for this application will be described by the embodiments. It should be noted that this device will work with controllers for the PS4, PS3, and Xbox.

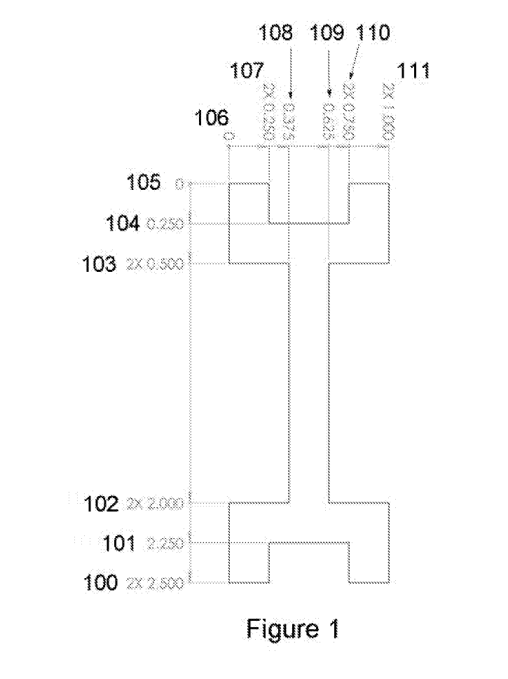

A first embodiment of the device 100 is illustrated in FIG. 1. The measurement 100 includes the end measurement moving from the beginning 105 to the end of the device 100. The measurement shows 2.500 inches for total length of the device. The 2× shown in this measurement demonstrates 2 sides for this device.

A second embodiment of the device 101 is illustrated in FIG. 1. The measurement 101 includes the measurement of 2.250 inches for from the beginning 105 length measurement.

A third embodiment of the device 102 is illustrated in FIG. 1. The measurement 102 includes the measurement of 2.000 inches from the beginning 105 length measurement. The 2× shown in this measurement demonstrates 2 sides for this device. This also illustrates the length of the middle section of the device. This section is the pliable section that will bend while being inserted on the controller.

A fourth embodiment of the device 103 is illustrated in FIG. 1. The measurement 103 includes the measurement of 0.500 inches from the beginning 105 length measurement. The 2× shown in this measurement demonstrates 2 sides for this device.

A fifth embodiment of the device 104 is illustrated in FIG. 1. The measurement 104 includes the measurement of 0.250 inches from the beginning 105 length measurement.

A sixth embodiment of the device 105 is illustrated in FIG. 1. The measurement 105 is the beginning corner of the length of the device and shows 0 measurement.

A seventh embodiment of the device 106 is illustrated in FIG. 1. The measurement 106 is the beginning corner of the width of the device and shows 0 measurement.

An eight embodiment of the device 107 is illustrated in FIG. 1. The measurement 107 includes the measurement of 0.250 inches from the beginning 106 width measurement. The 2× shown in this measurement demonstrates 2 sides for this device.

A ninth embodiment of the device 108 is illustrated in FIG. 1. The measurement 108 includes the measurement of 0.375 inches from the beginning 106 width measurement.

A tenth embodiment of the device 109 is illustrated in FIG. 1. The measurement 109 includes the measurement of 0.625 inches from the beginning 106 width measurement.

An eleventh embodiment of the device 110 is illustrated in FIG. 1. The measurement 110 includes the measurement of 0.750 inches from the beginning 106 width measurement. The 2× shown in this measurement demonstrates 2 sides for this device.

A twelfth embodiment of the device 111 is illustrated in FIG. 1. The measurement 111 includes the measurement of 1.000 inches from the beginning 106 width measurement. The 2× shown in this measurement demonstrates 2 sides for this device. 106 through 111 demonstrate the total length of the device for both ends.

The present application has a specific advantage. The measurement between 103 and 102 is the pliable section that allows the device to bend to be inserted onto a controller. Once inserted onto a controller during a live game, the character will remain active so that the player can step away from the game without being removed from the game. When a player is removed from the game, they cannot easily return to the same game.

The device is manufactured using a hydraulic punch press with an acrylic die to press the shape using Lexan plastic material. The Lexan plastic is placed into the press, the acrylic die is placed on top of the Lexan plastic. The top of the punch press when engaged comes down onto the die punching the shape into the plastic.

1. A device comprising of 2 open squares at each end are specifically measured to hold analogue sticks in an outward position on a controller.

2. A device comprising of a specifically measured pliable middle section to bend to allow the device to be inserted in between analogue sticks on a controller.
